(19) United States
(12) Patent Application Publication
(10) Pub. No.: US 2026/0078864 A1
(43) Pub. Date: Mar. 19, 2026

(54) DISPLAY MOUNTING APPARATUS

(71) Applicant: FLEXISPOT INC., Irvine, CA (US)

(72) Inventors: Lehong XIANG, Irvine, CA (US); Xin JIN, Irvine, CA (US); Minquan TAO, Irvine, CA (US); Jie FU, Irvine, CA (US)

(21) Appl. No.: 19/244,754

(22) Filed: Jun. 20, 2025

(30) Foreign Application Priority Data
Sep. 14, 2024 (CN) 202411292125.6
Sep. 14, 2024 (CN) 202422266006.5

(51) Int. Cl. F16M 11/20

(52) U.S. Cl. CPC F16M 11/2021; F16M 2200/068

(57) ABSTRACT

A display mounting apparatus includes a mounting plate and at least one tilt angle adjustment bracket including a rotatable bracket. The rotatable bracket adjusts tilt angle and distance between the connecting plate and the supporting frame assembly simultaneously and connects supporting frame assembly and connecting plate. The rotatable bracket includes at least one set of supporting arms which includes a first supporting arm and a second supporting arm which are pivotally connected in an X shape through a pivot, upper and lower ends of the first supporting arm are rotatably connected to supporting frame assembly and connecting plate respectively, upper and lower ends of the second supporting arm are slidably connected to connecting plate and supporting frame assembly. A distance from the upper end of the first supporting arm to the pivot is greater than a distance from the lower end of the first supporting arm to the pivot.

The present application claims the priorities of Chinese Patent Application No. 202411292125.6 filed to China National Intellectual Property Administration on September 14, 2024, Chinese Patent Application No. 202422266006.5 filed to China National Intellectual Property Administration on September 14, 2024, which are hereby incorporated by reference in their entireties.

### TECHNICAL FIELD

The present application relates to the field of display support, in particular, to a display mounting apparatus.

### BACKGROUND

Display mounting apparatuses, also known as TV supports, are mounting apparatuses specifically designed for hanging flat-panel televisions and flat-panel displays on walls, screens and other supports. They are suitable for living rooms, bedrooms, offices, conference halls, exhibition halls, hotels, airports, railway stations, hospitals, bus stations, shopping malls and other places.

The display mounting apparatus of the related art generally includes a mounting plate connected to the support and a hanging plate connected to the back of the display, and a connecting structure is provided between the hanging plate and the mounting plate. During installation, the mounting plate is connected to the support firstly, and the mounting plate is provided with a hanging portion extending along the length direction of the mounting plate, and the bottom of the mounting plate is provided with a plurality of connecting holes. The hanging plate is pre-installed on the back of the display, and the upper end of the hanging plate is provided with a hook connected to the hanging portion, and the lower end of the hanging plate is connected to a locking screw or an elastic bayonet. The hook on the upper end of the hanging plate is hung on the hanging portion of the mounting plate, and then the locking screw or the elastic bayonet is detachably connected to the bottom of the mounting plate. Some display mounting apparatus in the prior art are generally designed to be of small thickness or volume, so that the distance between the display and the wall is set closer, which can save indoor space and ensure the aesthetics of the combination between the display and the wall. However, the tilt angle of the display mounting apparatus cannot be adjusted, thus a better viewing experience cannot be achieved.

For example, there are some wall-mounted TV brackets in the prior art, whose display tilt angle can be adjusted to meet users’ better viewing experience. Specifically, a folding arm is arranged between the mounting plate and the connecting plate, and the connecting plate is rotatably connected to the folding arm through a rotating shaft, and an arc hole centered on the rotating shaft is arranged on the display connecting plate, and a locking knob is threadedly connected to the folding arm and passes through the arc hole. The connecting plate together with the display can be rotated around the rotating shaft to adjust the tilt angle of the display, and is locked by the locking knob.

The display mounting apparatus of the above-mentioned related technology has the following defects in actual use. Firstly, adjusting the tilt angle is very laborious for users, especially for large-sized displays, which are heavy in themselves.It is particularly laborious to adjust the tilt angle, and it is difficult to adjust to a suitable tilt angle at one time. Secondly, the display mounting apparatus of the related technology generally has poor load-bearing capacity, especially when users are adjusting the tilt angle of the display, the center of gravity of the display will also change greatly, resulting in poor connection stability of the display. The thickness and volume of the display stand of the prior art are small, which inevitably affect the adjustment range of the tilt angle of the display, especially for large-sized displays, the bottom edge of which often touches the wall when the display is tilted downward. In addition, after the hanging plate on the back of the display is hung on the mounting plate on the wall, the space on the back of the display is very small, and it is difficult to connect the wiring of the display to the socket on the wall behind the display. For this reason, before the hanging plate is hung on the mounting plate, it is necessary to connect the wiring of the display to the socket first, and then hang the hanging plate on the mounting plate, but when the hanging plate is hung, the connected wiring may interfere with the socket or other plugs on the plug.

### SUMMARY

The present application is to provide a display mounting apparatus, including a mounting plate connected to a surface of a support and at least one tilt angle adjustment bracket, each tilt angle adjustment bracket including:

a supporting frame assembly configured to be connected to the mounting plate;

a connecting plate configured to be connected to a back surface of a display; and

a rotatable bracket, which connects the supporting frame assembly and the connecting plate, configured to adjust a tilt angle and a distance between the connecting plate and the supporting frame assembly to make the connecting plate stay at any position of its trajectory, the rotatable bracket includes at least one set of supporting arms, each set of supporting arms includes a first supporting arm and a second supporting arm, the first supporting arm and the second supporting arm are pivotally connected in an X shape through a pivot, an upper end of the first supporting arm is rotatably connected to the supporting frame assembly, and a lower end of the first supporting arm is rotatably connected to the connecting plate; an upper end of the second supporting arm is slidably connected to the connecting plate, and a lower end of the second supporting arm is slidably connected to the supporting frame assembly; the rotatable bracket is configured to simultaneously adjust the tilt angle and the distance between the connecting plate and the supporting frame assembly;

where, a distance from the upper end of the first supporting arm to the pivot is greater than a distance from the lower end of the first supporting arm to the pivot, or a distance from the upper end of the second supporting arm to the pivot is greater than the distance from the lower end of the first supporting arm to the pivot.

In one embodiment, a slideway with a higher outer end and a lower inner end and a smooth transition is disposed on the connecting plate, and a first sliding member connected to the upper end of the second supporting arm is in a sliding cooperation with the slideway; an elongated slot extending along a height direction of the supporting frame assembly is disposed on the supporting frame assembly, and a second sliding member connected to the lower end of the second supporting arm is in a sliding cooperation with the elongated slot.

In one embodiment, the slideway is an arc-shaped slot or an inclined slot disposed on the connecting plate.

In one embodiment, a distance between a top of the display and the surface of the support is smaller than a distance between a bottom of the display and the surface of the support, when the connecting plate moves from a second position to a first position and further moves beyond the first position, wherein the connecting plate is at the first position when the display is close and parallel to the surface of the support and the connecting plate is at the second position when the display is at a maximum tilt angle with the top end away from the surface of the support.

In one embodiment, at least one set of positioning members is connected to the supporting frame assembly, and each set of positioning members includes two positioning plates that are arranged opposite to each other and made of soft elastic material, and when the connecting plate moves close to the supporting frame assembly and reaches an extreme position, the connecting plate is elastically clamped between the two positioning plates.

In one embodiment, a hook, configured to match and hang on the top of the mounting plate, is disposed on the supporting frame assembly, and a clamping member is slidably connected to the supporting frame assembly, and the clamping member is configured to movably clamp the mounting plate at a bottom of the mounting plate; an elastic member is connected between the clamping member and the supporting frame assembly, and the elastic member is configured to make the clamping member constantly have a movement tendency to clamp the bottom of the mounting plate.

In one embodiment, a driving member is connected to the clamping member, and the driving member is configured to drive the clamping member to separate from the bottom of the mounting plate.

In one embodiment, two tilt angle adjustment brackets are respectively arranged on both sides of the mounting plate.

Some of the additional aspects and advantages of the present application will be explained in the following description, which can become apparent from the following description or be understood through practice of the present application.

### BRIEF DESCRIPTION OF DRAWINGS

A brief description of the drawings, which are incorporated in the description of embodiments, will be provided below to illustrate technical solutions of the present application clearly. Obviously, the drawings described below are merely some embodiments of the present application. For those skilled in the art, other drawings can be obtained based on these drawings without making inventive efforts.

FIG. 1 is a schematic structural diagram of a display mounting apparatus in one embodiment of the present application.

FIG. 2 is a schematic structural diagram from a back view of a display mounting apparatus in one embodiment of the present application.

FIG. 3 is a schematic structural diagram of a sectional view of a display mounting apparatus in one embodiment of the present application.

FIG. 4 is a schematic structural diagram of a tilt angle adjustment bracket in one embodiment of the present application.

FIG. 5 is an exploded schematic structural diagram of a tilt angle adjustment bracket in one embodiment of the present application.

FIG. 6 is a schematic structural diagram of a tilt angle adjustment bracket, where a connecting plate reaches a first position, in one embodiment of the present application.

FIG. 7 is a schematic structural diagram of a tilt angle adjustment bracket, where a connecting plate reaches a middle position, in one embodiment of the present application.

FIG. 8 is a schematic structural diagram of a tilt angle adjustment bracket, where a connecting plate reaches a second position, in one embodiment of the present application.

FIG. 9 is a schematic structural diagram of a display mounting apparatus in another embodiment of the present application.

FIG. 10 is a schematic structural diagram of part of a display mounting apparatus in one embodiment of the present application.

FIG. 11 is a schematic structural diagram of a display mounting apparatus in another embodiment of the present application.

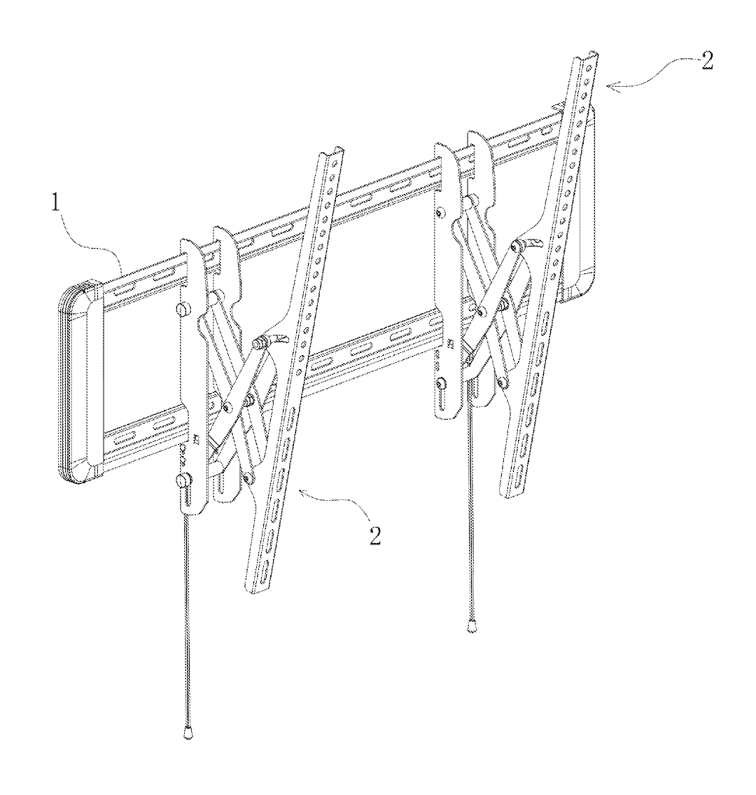

### DETAILED DESCRIPTION

Firstly, those skilled in the art should understand that these implementations are only used to explain the technical principles of the embodiments of the present application, and are not intended to limit the protection scope of the embodiments of the present application. Those skilled in the art can make adjustments to them as needed to adapt to specific application scenarios.

In the description of the embodiments of the present application, it should be noted that, unless otherwise clearly specified and limited, the terms "connected", "connection" and the like should be understood in a broad sense. For example, it can be a fixed connection, a detachable connection, or an integral connection; it can be a mechanical connection or an electrical connection; it can be directly connected or indirectly connected through an intermediate medium. For those skilled in the art, the specific meanings of the above terms in the embodiments of the present application can be understood according to specific circumstances.

In the embodiments of the present application, unless otherwise clearly specified and limited, a first feature is "above", "below" and the like a second feature may mean that the first and second features are in direct contact, or the first and second features are in indirect contact through an intermediate medium. Moreover, the first feature being "above" the second feature may mean that the first feature is directly above or obliquely above the second feature, or simply means that the first feature is higher in level than the second feature. The first feature being "below" the second feature may mean that the first feature is directly below or obliquely below the second feature, or simply means that the first feature is lower in level than the second feature.

The present application is further described in detail below with reference to the drawings and specific embodiments.

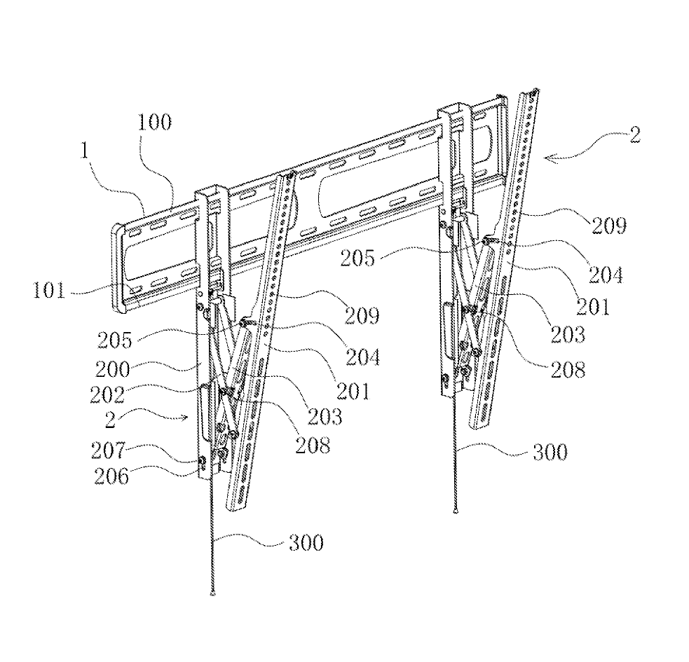

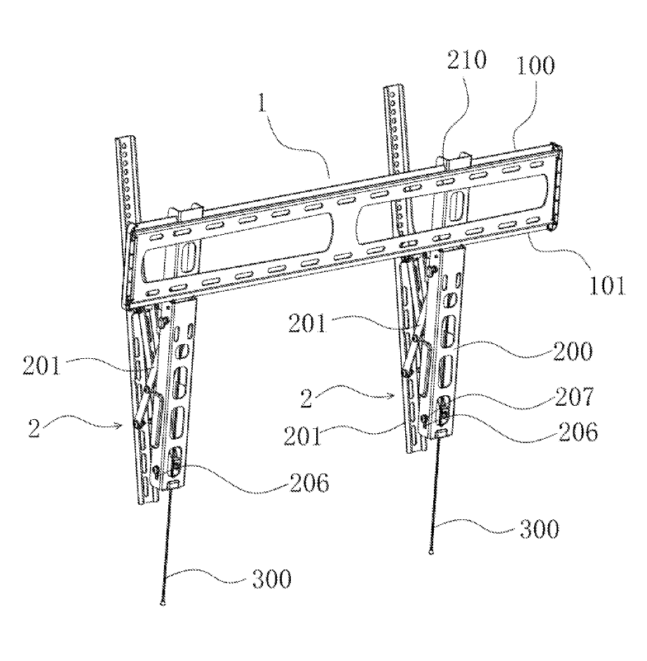

As shown in FIGS. 1 and 2, the present application discloses a display mounting apparatus, which can be installed on a surface of a support such as a wall, a fence or a screen, and can be used for mounting a display. The display mounting apparatus includes a mounting plate 1 connected to the surface of the support and at least one tilt angle adjustment bracket 2. The mounting plate 1 has a first surface closer and parallel to the surface of the support and a second surface further away from the surface of the support. The second surface is also a vertical plane parallel to the surface of the support. A top flange 100 and a bottom flange 101 of the mounting plate 1 are both formed by bent metal plates, and there exist gaps between the surface of the support and the top flange 100 as well as bottom flange101, which facilitates the installation of the tilt angle adjustment bracket 2.

In some embodiments, there are two tilt angle adjustment brackets 2, which are respectively arranged on both sides of the mounting plate 1. Each tilt angle adjustment bracket 2 includes a supporting frame assembly 200, a connecting plate 201 and a rotatable bracket. The supporting frame assembly 200 is configured to be hung on the mounting plate 1. A connecting hole 209, which can match a mounting hole on the back of the display, is disposed on the connecting plate 201. The connecting plate 201 can be installed on the back of the display by connecting screws. The rotatable bracket connects the supporting frame assembly 200 and the connecting plate 201, and is configured to adjust a tilt angle and a distance between the connecting plate 201 and the supporting frame assembly 200.

In some embodiments, as shown in FIGS. 1-4, the rotatable bracket includes at least one set of supporting arms, each set of supporting arms includes a first supporting arm 202 and a second supporting arm 203, the first supporting arm 202 and the second supporting arm 203 are pivotally connected in an X shape through a pivot 208. A distance from an upper end of the first supporting arm 202 to the pivot is greater than a distance from a lower end of the first supporting arm 202 to the pivot. The upper end of the first supporting arm 202 is rotatably connected to the supporting frame assembly 200, and the lower end of the first supporting arm 202 is rotatably connected to the connecting plate 201. An upper end of the second supporting arm 203 is slidably connected to the connecting plate 201, and a lower end of the second supporting arm 203 is slidably connected to the supporting frame assembly 200. The rotatable bracket is configured to simultaneously adjust the tilt angle and the distance between the connecting plate 201 and the supporting frame assembly 200.

The rotatable bracket allows the display on the connecting plate 201 to adjust its tilt angle between a first position and a second position, where the first position is the vertical position of the display, or the vertical position or folded position of the connecting plate 201. As the rotatable bracket is at a folded position, the display is close to and parallel to the surface of the support. The second position is a maximum tilt angle position of the display, which is, the maximum distance position of a top end of the display away from the surface of the support. As the rotatable bracket is at an unfolded position, the display on the connecting plate 201 is at a downward tilting extreme angle. The rotatable bracket is configured to adjust the tilt angle of the display to offer the viewing experience at different angles for users.

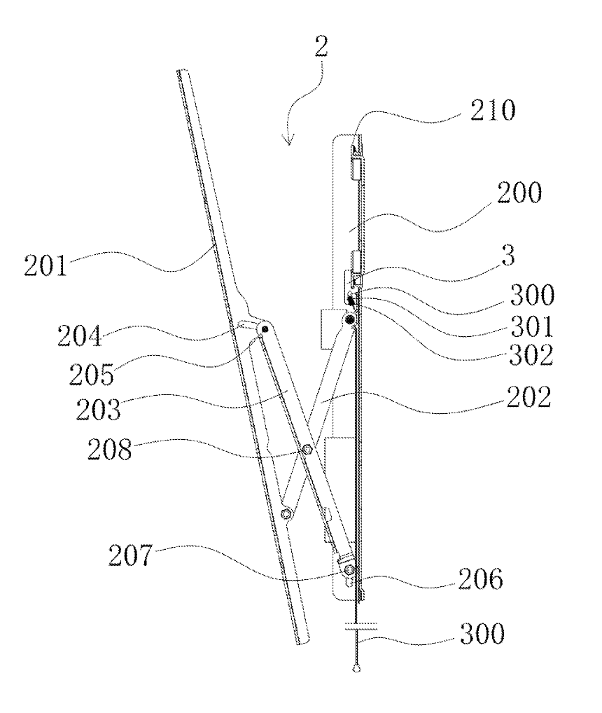

It is not difficult to understand that, to rotate the top end of the display in a direction away from the surface of the support to make the display in a tilted state, the user needs to hold the top end of the display with his hands and apply a pulling force outward. If the rotating force arm of the top of the rotatable bracket is small, a great force is required to rotate the display. Especially for a large-sized display with a heavy weight, it is more difficult to rotate and adjust the tilt angle. In the present application, as shown in FIG. 3, the distance from the upper end of the first supporting arm 202 of the rotatable bracket to the pivot 208 is greater than the distance from the lower end of the first supporting arm 202 to the pivot 208. Therefore, the lengths of the first supporting arm 202 on both sides of the pivot 208 are different, and the length of the part above the pivot 208 is greater than the length of the part below the pivot 208, this not only ensures the tilt angle adjustment of the display on the connecting plate 201, but also increases the rotating force arm of the upper part of the connecting plate 201. When the top end of the display is rotated to move in a direction away from the surface of the support, it is more labor-saving. Even if the connected display is large-sized , it is very labor-saving and convenient when the top of the display is being rotated.

In some embodiments, in order to save effort in rotating the top end of the display, a distance from the upper end of the second supporting arm to the pivot is greater than the distance from the lower end of the first supporting arm to the pivot, which also increases the rotating force arm at the upper part of the connecting plate and saves effort in rotation.

Furthermore, the display mounting apparatus makes it very labor-saving to rotate the top end of the display away from the surface of the support. To prevent the top end of the display from being accidentally rotated, the display mounting apparatus further allows the connecting plate 201 to move from the second position to the first position and further move beyond the first position. Therefore, the distance between the top end of the display and the surface of the support is smaller than the distance between the bottom end of the display and the surface of the support, thereby preventing the top end of the display from being accidentally rotated.

For those display mounting apparatuses in the prior art, when the top end of the display moves away from the surface of the support to adjust the tilt angle of the display, the center of gravity of the display will inevitably move downward, thereby changing the load condition of the display mounting apparatus and affecting the connection stability of the display. In addition, in the process of adjusting the tilt angle, the bottom end of the display will move toward the surface of the support and may collide with the surface of the support. In the present application, in order to solve the problem of deviation of the center of gravity of the display, improve the load-bearing capacity of the display mounting apparatus, and avoid the bottom end of the display from colliding with the surface of the support, the upper end of the second arm 203 is slidably connected to the connecting plate 201, and the lower end of the second arm 203 is slidably connected to the supporting frame assembly 200, as shown in FIGS. 1-5. When adjusting the tilt angle and distance of the display, the first supporting arm 202 and the second supporting arm 203 are rotated and unfolded to make the top end of the display move and tilt away from the surface of the support. The two ends of the second supporting arm 203 can slide on the connecting plate 201 and the supporting frame assembly 200 respectively to adjust the center of gravity of the display in real time and adaptively adjust the distance between the bottom end of the display on the connecting plate 201 and the wall. Therefore the center of gravity of the display is at the same level or approximately the same level during the entire tilt angle adjustment process. In this way, the connection stability of the display is good. In other words , the display mounting apparatus can provide a strong load-bearing capacity. In addition, the distance between the bottom end of the display and the surface of the support is constantly kept fixed or within a certain safe distance range to prevent the bottom end of the display from hitting the surface of the support.

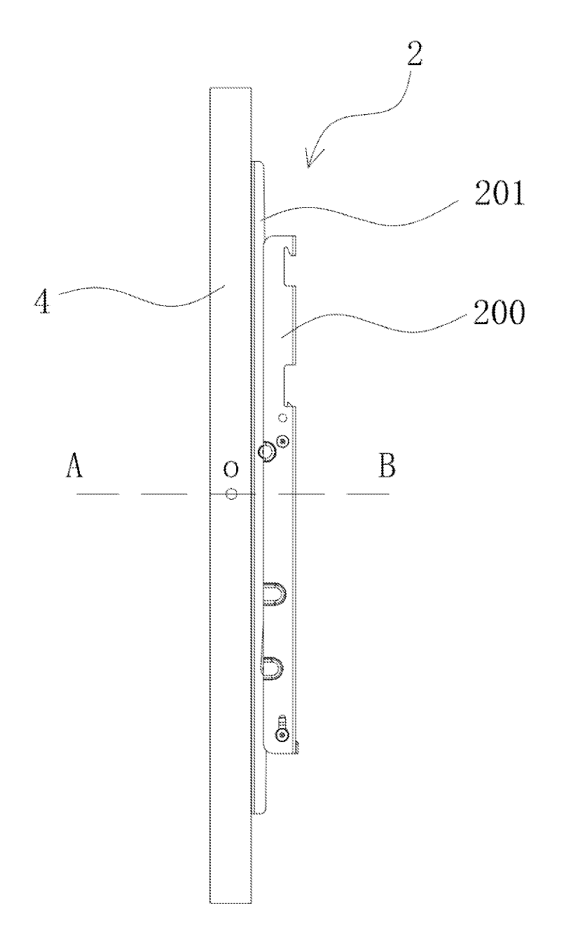

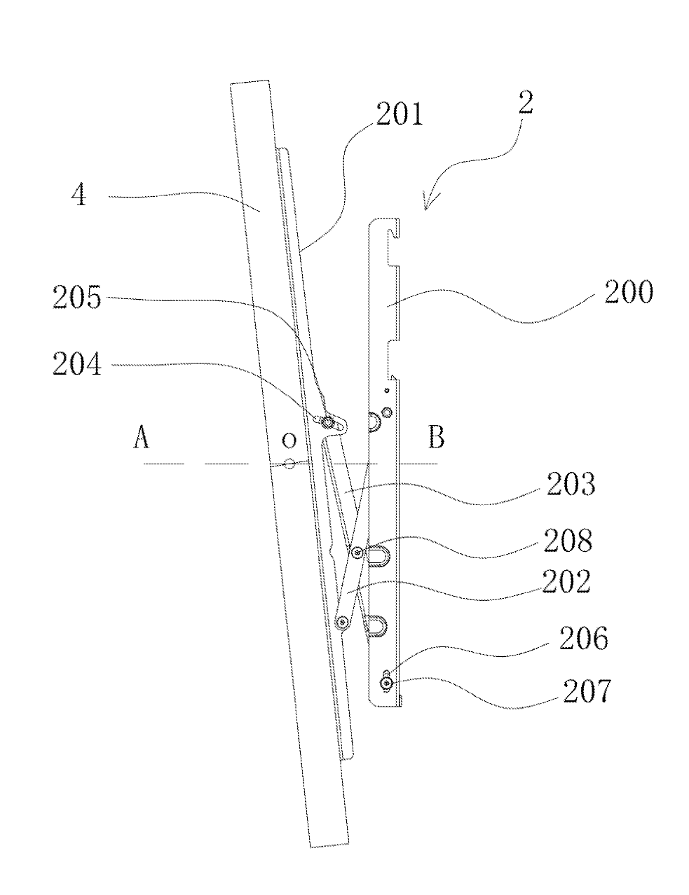

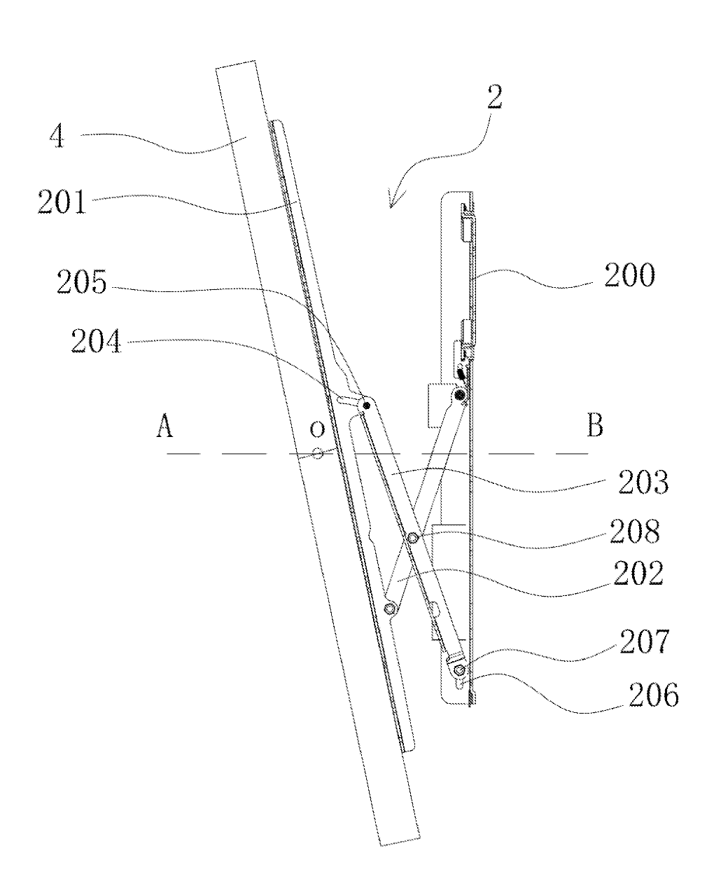

For example, as shown in FIGS. 6-8, FIG. 6 shows that the display 4 is at a vertical position parallel to the surface of the support, that is, the first position. FIG. 7 shows that the upper end of the display 4 is rotated 6 degrees away from the surface of the support so that the display 4 is in a tilted middle position. FIG. 8 shows that the upper end of the display 4 is rotated 12 degrees away from the surface of the support so that the display 4 is at the second position with the maximum tilt angle. In addition, FIGS. 6-8 all show the center of gravity O of the display 4 as well as its movement trajectory during the entire tilt angle adjustment process, in which the trajectory height is shown by the horizontal line A-B. In FIG. 6, the rotatable bracket is at a fully folded position, and the display 4 is arranged parallel to the surface of the support. At this position, the distance between the display 4 and the surface of the support is the shortest, and the center of gravity O of the display 4 is located on the horizontal line A-B. Moreover, the supporting frame assembly 200 can be hung on the mounting plate 1. In FIG. 7, the distance between the top end of the display 4 and the surface of the support is greater than the distance between the bottom end of the display 4 and the surface of the support, where the display 4 is in a tilted position, and the center of gravity O of the display 4 is still located around the horizontal line A-B. Therefore, in the process of rotating from the position shown in FIG. 6 to the position shown in FIG. 7, the downward movement of the center of gravity O of the display 4 is offset by the upward movement of the two ends of the second arm 203, so that the center of gravity O of the display 4 is maintained at almost the same horizontal height. In FIG. 8, the display 4 is in the maximum tilted position, and the center of gravity O of the display 4 is still located around the horizontal line A-B. In the process of rotating from the position shown in FIG. 7 to the position shown in FIG. 8, the downward movement of the center of gravity O of the display 4 is again offset by the upward movement of the two ends of the second arm 203, so that the center of gravity O of the display 4 is maintained at almost the same horizontal height. That is, in the entire tilt angle and distance adjustment range of the display 4, the center of gravity O is always maintained at almost the same horizontal height, so that the force exerted by the display 4 on the supporting frame assembly 200 and the mounting plate 1 is constant, so that the stability of the connection of the display 4 is good, and the load-bearing capacity of the display mounting apparatus is strong.

It is understandable that due to the influence of manufacturing precision errors and assembly clearance errors, during the process of adjusting the tilt angle and distance of the display 4, the center of gravity of the display will inevitably deviate from the horizontal line AB, but the deviation is relatively small, such as between 0 and 10 mm. Therefore, in fact, during the process of adjusting the tilt angle and distance of the display , the center of gravity of the display is roughly or approximately at the same horizontal height.

It is not difficult to understand that the tilt angle and distance adjustment of the display is performed by moving the top end of the display away from the support surface. During the adjustment process, the bottom end of the display is slightly away from the support surface, but the distance from the bottom end of the display to the support surface is smaller than the distance from the top end of the display to the support surface. Therefore , with the rotatable bracket, when the top end of the display 4 moves and tilts away from the surface of the support, the bottom end of the display 4 will also move away from the surface of the support, so that the distance between the bottom end of the display and the surface of the support surface can be constantly kept fixed or kept within a certain safe distance range.

In a possible implementation, the size of the display may be 100 inches. In the position shown in FIG. 6, the minimum distance between the bottom end of the display and the surface of the support can be referred to as D1, in the position shown in FIG. 7, the minimum distance between the bottom end of the display and the surface of the support can be referred to as D2, in the position shown in FIG. 8, the minimum distance between the bottom end of the display and the surface of the support can be referred to as D3, the values of D1, D2 and D3 can be almost the same.

Similarly, because of the above-mentioned inevitable manufacturing precision errors and assembly clearance errors, within the entire tilt angle adjustment range of the display, the values of the minimum distances D1, D2 and D3 between the bottom of the display and the surface of the support may be slightly different. Nevertheless, they can be regulated to remain within the safety distance range such as a range of 4 to 6 cm, where D1 may be 5 cm, D2 may be 5.5 cm, D3 may be 4.8 cm, etc. Referring to the positions shown in FIGS. 7-8, even if a larger-sized display is connected, the bottom end of the display will not touch the surface of the support during the tilt angle and distance adjustment process, especially when the display is tilted to the maximum angle.

In some embodiments, the rotational cooperation between the first supporting arm 202 and the second supporting arm 203 of the rotatable bracket and the connection relationship between the first supporting arm 202 as well as the second supporting arm 203 and the connecting plate 201 and the supporting frame assembly 200 enable the tilt angle of the connecting plate 201 relative to the supporting frame assembly 200 to be adjustable. Therefore, during the installation process, the display may be installed on the connecting plate 201 firstly, and the wiring of the display may be connected to the socket on the surface of the support, and then the supporting frame assembly 200 of the tile angle adjustment bracket 2 may be hung on the mounting plate 1. To prevent the wiring of the display from interfering with the socket on the surface of the support, the bottom end of the display can be rotated away from the support surface so that the bottom end of the display can be slightly away from the surface of the support. Thereby the interference of the display wiring with the socket on the support surface can be avoided.

In some embodiments, during the entire tilt angle adjustment process of the display mounting apparatus, the display on the connecting plate 201 can stay at any position of its movement, and there's no need to additionally arrange a locking mechanism to lock the connecting plate 201 after the angle adjustment. The rotatable bracket can keep the display staying at any position of its trajectory with friction. Specifically, a friction plate may be installed at any rotating connection of the rotatable bracket. For example, the friction plate can be arranged on the pivot 208, a rotating pivot at any end of the first supporting arm 202, or the sliding connection between the connecting plate 201 and the second supporting arm 203. The friction provided by the friction plate can make the connecting plate 201 stay after rotating, thereby ensuring that the display can stay at any position of its trajectory.

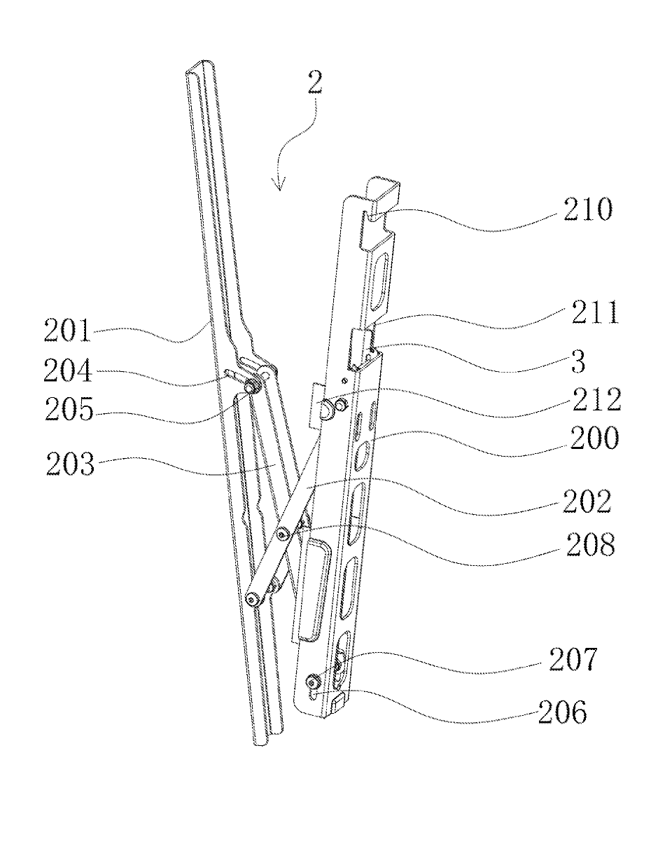

As shown in FIGS. 3-4, in some embodiments, a slideway 204 with a higher outer end and a lower inner end and a smooth transition in is disposed on the connecting plate, and a first sliding member 205 connected to the upper end of the second supporting arm 203 is in a sliding cooperation with the slideway 204. An elongated slot 206 extending along a height direction of the supporting frame assembly is disposed on the supporting frame assembly 200, and a second sliding member 207 connected to the lower end of the second supporting arm 203 is in a sliding cooperation with the elongated slot 206. When the display is at the first position, the rotatable bracket is at a folded position, the first sliding member 205 at the first end of the second supporting arm 203 is positioned at one end, which is further away from the mounting plate 1, of the slideway 204, and the second sliding member 207 at the second end of the second supporting arm 203 is positioned at the lower end of the elongated slot 206. When the top end of the display moves and tilts in the direction away from the surface of the support, the first sliding member 205 at the first end of the second supporting arm 203 slides in the slideway 204 toward one end, which is closer to the mounting plate 1, of the slideway 204, and the second sliding member 207 at the second end of the second supporting arm 203 slides in the elongated slot 206 toward the upper end of the elongated slot 206. That is, in the process of the display rotating and tilting from the first position to the second position, the supporting height of the second supporting arm 203 is increased, so as to offset the height of the center of gravity of the display that drops when it is tilted.

In some embodiments, a length of the slideway 204 and a length of the long slot 206 can be designed according to the tilt angle adjustment range of the display. The first sliding member 205 and the second sliding member 207 are two pivots which are connected to the two ends of the second supporting arm 203 respectively.

Specifically, as shown in FIG. 3, the slideway 204 may be an arc-shaped slot on the connecting plate 201, and a horizontal height of one end, which is closer to the supporting frame assembly 200 and is referred as the inner end above, of the arc-shaped slot is lower than a horizontal height of one end, which is further away from the supporting frame assembly 200 and is referred to as the outer end, of the arc-shaped slot. Therefore, the inner end of the arc-shaped slot is lower and the outer end is higher.

In some embodiments, the slideway 204 on the connecting plate 201 may be an inclined straight-line slot, and a horizontal height of the end, which is closer to the supporting frame assembly 200 and is referred to as the inner end above, of the inclined slot is lower than a horizontal height of the end ,which is further away from the supporting frame assembly 200 and is referred as the outer end, of the inclined slot.

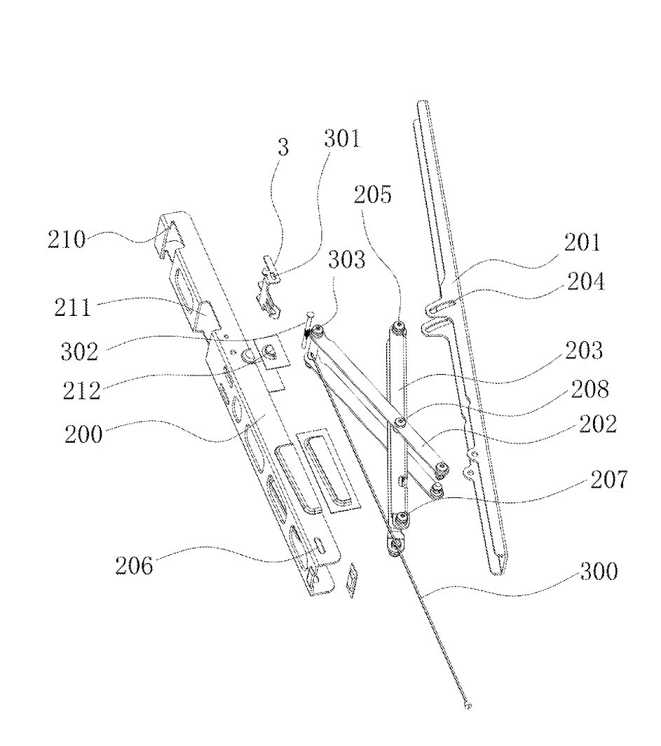

As shown in FIGs.4-5, in order to prevent the display 4 from being accidentally opened when it is in the first position or in a vertical position parallel to the surface of the support, and to make the connection plate 201 be more stably connected to the supporting frame assembly 200 when the rotatable bracket is at the folded position, at least one set of positioning members is connected to the supporting frame assembly 200, and each set of positioning members includes two positioning plates 212 that are arranged opposite to each other and made of soft elastic material. When the connecting plate 201 moves close to the supporting frame assembly 200 and reaches an extreme position, the connecting plate 201 is elastically clamped between the two positioning plates 212.

In a possible implementation, as shown in FIGS. 5-6, the supporting frame assembly 200 is a U-shaped structure formed by bending a metal plate, whose opening faces the connecting plate 201. When the rotatable bracket is folded to position the display at the first position, the connecting plate 201 is at least partially accommodated in the supporting frame assembly 200. Mounting grooves are disposed on the two inner side walls of the supporting frame assembly 200 on the side closer to the connecting plate 201, and one soft positioning plate 212 made of rubber is connected in each mounting groove. Specifically, when the connecting plate 201 drives the display to move toward the supporting frame assembly 200, the connecting plate 201 can be elastically clamped between the two positioning plates 212, thereby positioning and fixing the connecting plate 201. In some embodiments, two sets of positioning members are respectively arranged corresponding to the first sliding member 205 and the pivot at the lower end of the first supporting arm 202, and both ends of the first sliding member 205 and both ends of the pivot at the lower end of the first supporting arm 202 extend outward from the surface of the connecting plate 201. Therefore, the positioning plates 212 can play a good positioning role on both ends of the first sliding member 205 and both ends of the pivot at the lower end of the first supporting arm 202, which can avoid a hard collision with the supporting frame assembly 200.

In some embodiments, the supporting frame assembly 200 is hung on the mounting plate 1. In order to facilitate the supporting frame assembly 200 to be hung on the mounting plate 1 and prevent the supporting frame assembly 200 from accidentally detaching from the mounting plate 1 after being hung, as shown in FIGS. 1, 2 and 5, a hook 210 configured to match and hang on the top of the mounting plate 1, is disposed on the supporting frame assembly 200, and a clamping member 3 is slidably connected to the supporting frame assembly 200, where the clamping member 3 is configured to movably clamp the mounting plate 1 at a bottom of the mounting plate 1. An elastic member 303 is connected between the clamping member 3 and the supporting frame assembly 200, and the elastic member 303 is configured to make the clamping member 3 constantly have a movement tendency to clamp the bottom of the mounting plate 1.

In a possible implementation, as shown in FIGS. 2 and 5, a first notch is disposed on one side, which is closer to the mounting plate 1, of the upper end of the supporting frame assembly 200, and the hook 210 is formed at a top of the first notch to be hung on the top flange 100 of the mounting plate 1. A second notch 211 configured to be snapped on the bottom flange 101 of the mounting plate 1 is disposed on one side, which is closer to the mounting plate 1,of the supporting frame assembly 200. A positioning shaft 302 is connected to the supporting frame assembly 200, and the clamping member 3 is in a sliding cooperation with the supporting frame assembly 200, where a guiding slot 301 is disposed on the clamping member 3 for the positioning shaft 302 to pass through. The clamping member 3 has a U-shaped clamping portion, which can be snapped on the top flange 100 of the mounting plate 1 in the second notch 211 to prevent the bottom flange 101 of the mounting plate 1 from escaping from the second notch 211. Specifically, the elastic member 303 may be a coil spring, where one end of the coil spring is connected to the positioning shaft 302 and the other end of the coil spring is connected to the clamping member 3. With the effect of the spring force, a clamping portion of the clamping member 3 constantly has a movement tendency to clamp with the bottom flange 101 of the mounting plate 1. In order to further facilitate the hanging of the supporting frame assembly 200 and the mounting plate 1, a guiding slope is arranged on the outer wall of the clamping portion of the clamping member 3. When the hook 210 is to be hung on the top flange 100 of the mounting plate 1, the bottom flange 101 of the mounting plate 1 can overcome the spring force of the elastic member 303 and be quickly clamped into the second notch 211 the guide slope, as the supporting frame assembly 200 being pressed inward. Therefore, the clamping member 3 can be reset with the effect of the elastic member 303 and clamped to the bottom flange 101 of the mounting plate 1, thus the supporting frame assembly 200 can be locked on the mounting plate 1.

Furthermore, in order to facilitate the detachment between the supporting frame assembly 200 and the mounting plate 1, a driving member 300 is connected to the clamping member 3, and the driving member 300 is configured to drive the clamping member 3 to separate from the bottom of the mounting plate 1. As shown in FIGS. 1 and 5, the driving member 300 may be a pull rope or a pull rod, and an upper end of the pull rope or the pull rod is connected to the clamping member 3. When the clamping portion of the clamping member 3 is to be separated from the bottom flange 101 of the mounting plate 1, the pull rope or the pull rod can be pulled downward to drive the clamping member 3 to move downward, and the clamping portion of the clamping member 3 can be separated from the bottom flange 101 of the mounting plate 1. The operation is very simple and convenient.

In some embodiments, the first supporting arm 202 of the rotatable bracket may include two parallel supporting rods, and the second supporting arm 203 may be one rod of a U-shaped cross-section which is formed by bending an integrated metal plate. As shown in FIGS. 1, 2 and 5, the second supporting arm 203 is arranged between the two supporting rods and is rotatably connected to the two supporting rods through the pivot 208.

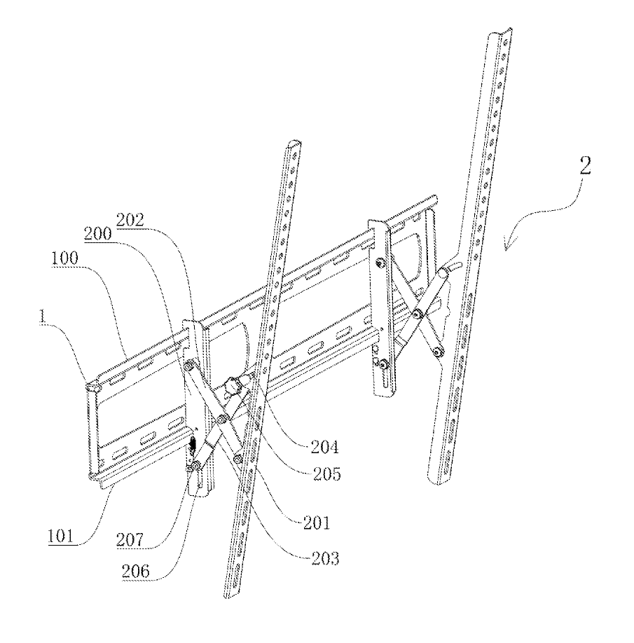

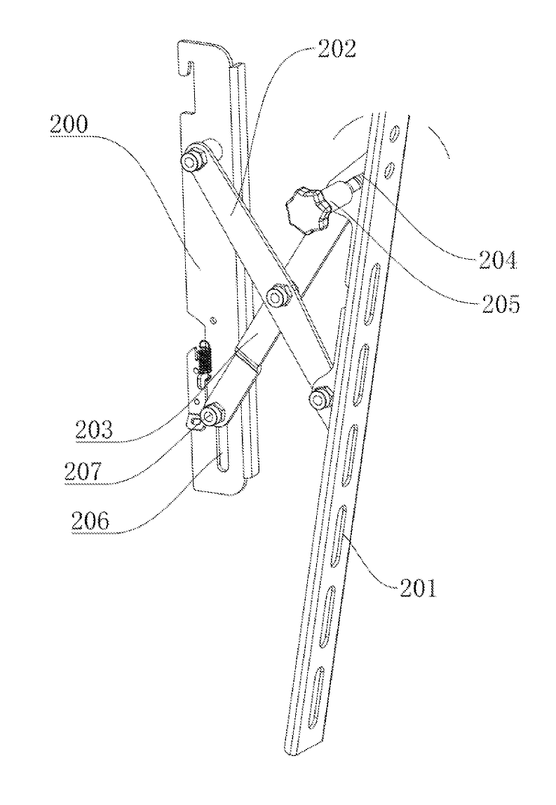

In some embodiments, as shown in FIGS. 9-10, the first supporting arm 202 of the rotatable bracket may be one supporting rod, and the second supporting arm 203 is configured as an elongated and thin rod or plate, and the first supporting arm 202 and the second supporting arm 203 are rotatably connected via the pivot 208 .

In some embodiments, the first supporting arm 202 of the rotatable bracket may be one supporting rod, and the second supporting arm 203 may include two parallel rods, and the first supporting arm 202 and the second supporting arm 203 are rotatably connected via a pivot.

In the present application, the supporting arms of the rotatable bracket may be all straight arms, or the supporting arms may be angled or arc-shaped arms. In addition, the present application does not impose any special limitation on the composition, structure or number of the first supporting arm and the second supporting arm of each set of arms. Any supporting arm that satisfies the purpose of the present application in which the first supporting arm and the second supporting arm are arranged in an X-shape and the intersection is rotatably connected to make the connecting plate be flipped, unfolded or folded relative to the supporting frame assembly will suffice.

In the description of the embodiments of the present application, it should be noted that in the description of the present application, terms such as "inside", "outside", "outer", "inner" and the like indicating directions or positional relationships are based on the directions or positional relationships shown in the drawings. This is only for the convenience of description, and does not indicate or imply that the apparatus or component must have a specific orientation, be constructed and operated in a specific orientation. Therefore, it cannot be understood as a limitation on the present application.

In the description of the present application, the description with reference to the terms "one embodiment", "some embodiments", "for example", "implementation", or "specifically" etc. means that the specific features, mechanisms, materials or characteristics described in conjunction with the embodiment or example or implementation are included in at least one embodiment or example or implementation of the present application. In this specification, the schematic representations of the above terms do not necessarily refer to the same embodiment or example or implementation. Moreover, the specific features, mechanisms, materials or characteristics described may be combined in a suitable manner in any one or more embodiments or examples or implementations. In addition, those skilled in the art may combine and combine the different embodiments or examples or implementation described in this specification and the features of the different embodiments or examples or implementation, without contradiction.

The above is only some possible implementations of the present application , but the protection scope of the present application is not limited thereto. Any changes or substitutions that can be easily thought of by those skilled in the art within the technical scope disclosed in the present application should be included in the protection scope of the present application. Therefore, the protection scope of the present application shall be based on the protection scope of the claims.

What is claimed is:

1. A display mounting apparatus, comprising a mounting plate connected to a surface of a support and at least one tilt angle adjustment bracket, each tilt angle adjustment bracket comprising:
a supporting frame assembly configured to be connected to the mounting plate;
a connecting plate configured to be connected to a back surface of a display; and
a rotatable bracket, which connects the supporting frame assembly and the connecting plate, configured to adjust a tilt angle and a distance between the connecting plate and the supporting frame assembly to make the connecting plate stay at any position of its trajectory, the rotatable bracket comprises at least one set of supporting arms, each set of supporting arms comprises a first supporting arm and a second supporting arm, the first supporting arm and the second supporting arm are pivotally connected in an X shape through a pivot, an upper end of the first supporting arm is rotatably connected to the supporting frame assembly, and a lower end of the first supporting arm is rotatably connected to the connecting plate; an upper end of the second supporting arm is slidably connected to the connecting plate, and a lower end of the second supporting arm is slidably connected to the supporting frame assembly; the rotatable bracket is configured to simultaneously adjust the tilt angle and the distance between the connecting plate and the supporting frame assembly;
wherein, a distance from the upper end of the first supporting arm to the pivot is greater than a distance from the lower end of the first supporting arm to the pivot, or a distance from the upper end of the second supporting arm to the pivot is greater than the distance from the lower end of the first supporting arm to the pivot.

2. The display mounting apparatus according to claim 1, wherein a slideway with a higher outer end and a lower inner end and a smooth transition is disposed on the connecting plate, and a first sliding member connected to the upper end of the second supporting arm is in a sliding cooperation with the slideway; an elongated slot extending along a height direction of the supporting frame assembly is disposed on the supporting frame assembly, and a second sliding member connected to the lower end of the second supporting arm is in a sliding cooperation with the elongated slot.

3. The display mounting apparatus according to claim 2, wherein the slideway is an arc-shaped slot or an inclined slot disposed on the connecting plate.

4. The display mounting apparatus according to claim 2, wherein a distance between a top of the display and the surface of the support is smaller than a distance between a bottom of the display and the surface of the support, when the connecting plate moves from a second position to a first position and further moves beyond the first position, wherein the connecting plate is at the first position when the display is close and parallel to the surface of the support and the connecting plate is at the second position when the display is at a maximum tilt angle with a top end of the display away from the surface of the support.

5. The display mounting apparatus according to claim 1, wherein at least one set of positioning members is connected to the supporting frame assembly, and each set of positioning members comprises two positioning plates that are arranged opposite to each other and made of a soft elastic material, and when the connecting plate moves close to the supporting frame assembly and reaches an extreme position, the connecting plate is elastically clamped between the two positioning plates.

6. The display mounting apparatus according to claim 1, wherein a hook, configured to match and hang on a top of the mounting plate, is disposed on the supporting frame assembly, and a clamping member is slidably connected to the supporting frame assembly, and the clamping member is configured to movably clamp the mounting plate at a bottom of the mounting plate; an elastic member is connected between the clamping member and the supporting frame assembly, and the elastic member is configured to make the clamping member constantly have a movement tendency to clamp the bottom of the mounting plate.

7. The display mounting apparatus according to claim 6, wherein a driving member is connected to the clamping member, and the driving member is configured to drive the clamping member to separate from the bottom of the mounting plate.

8. The display mounting apparatus according to any one of claim 1, wherein two tilt angle adjustment brackets are respectively arranged on both sides of the mounting plate.
